(19) United States
(12) Patent Application Publication
(10) Pub. No.: US 2024/0121734 A1
(43) Pub. Date: Apr. 11, 2024

(54) Time Synchronisation

(71) Applicant: McLaren Applied Technologies Limited, Horsell Woking Surrey (GB)

(72) Inventors: Pedro Luciano Palacios Umana, Woking, Surrey (GB); Marco Cattani, Cambridge (GB)

(21) Appl. No.: 18/543,743

(22) Filed: Dec. 18, 2023

Related U.S. Application Data
(62) Division of application No. 17/263,815, filed on Jan. 27, 2021, now Pat. No. 11,849,415.

(30) Foreign Application Priority Data
Jul. 27, 2018 (GB) 1812305.9

(51) Int. Cl. H04W 56/00; H04W 4/38; H04W 52/02

(52) U.S. Cl. CPC H04W 56/0015; H04W 4/38; H04W 52/0229; H04W 52/028; H04W 56/0065

(57) ABSTRACT

A device comprising: a wireless communication interface, the communication interface being capable of using an external signal processing device to support a transmission or reception communication event and being configured to provide a first output signal from the communication interface for disabling such a signal processing device after the communication event; a clock external to the communication interface; and a synchronisation circuit configured to receive the first output signal and to synchronise the clock in dependence on the timing of the first output signal.

### CROSS-REFERENCE TO RELATED APPLICATIONS

The subject patent application claims priority to, and all the benefits of, U.S. patent application Ser. No. 17/263,815, filed on Jan. 27, 2021, which is a 371 National Phase of International Application No. PCT/GB2019/052088, filed on Jul. 25, 2019, which claims the benefit of GB Patent Application No. 1812305.9, filed on Jul. 27, 2018, the entire contents of which are incorporated by reference herein.

### DETAILED DESCRIPTION

This invention relates to determining the timing status of a communication device and synchronising clocks in dependence on that status.

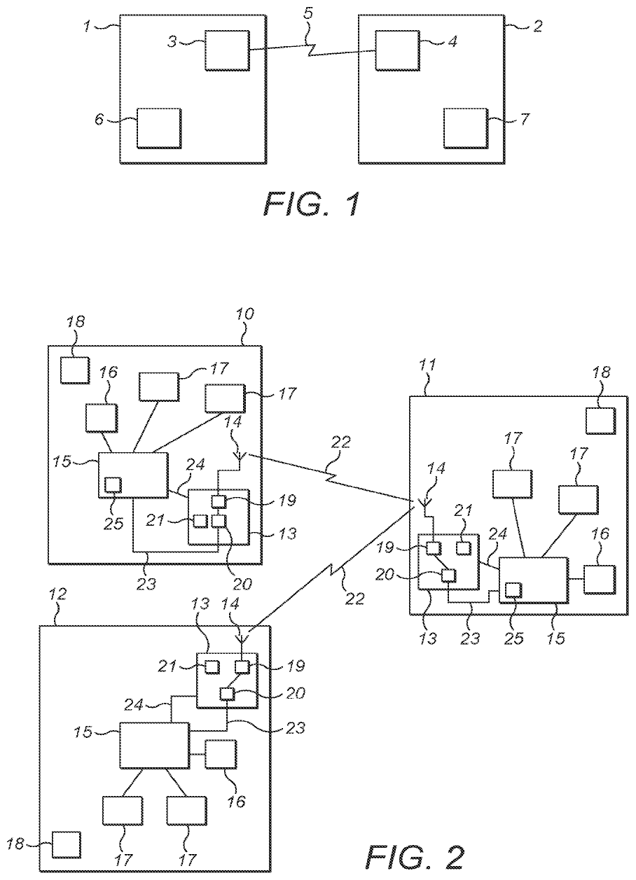

Communication devices perform events at different times. Those events may include transmitting, receiving and sensing or processing data locally. A communication device may include a clock. Events performed by the device may be designated to a time by reference to the clock. In many situations it is advantageous to determine aspects of the timing of operations performed by a communication device. One reason for doing so might be to help determine the relative timings of events that are sensed by independent sensing devices. For example, FIG. 1 shows two units 1, 2. Each unit has a communication device 3, 4. The communication devices can communicate wirelessly with each other, as illustrated at 5. The communication devices each include a respective clock. Each unit also has a sensor 6, 7. When the sensors sense events it may be useful to understand the relative timings of those events. This requires the local reference clocks of the units to be synchronised, so that the offset between them is known. A synchronisation process could be implemented in which one of the clocks is reset to match the other, so that the offset between the two clocks is zero. Alternatively, the offset (which might not be zero) can be determined and used to interrelate times indicated by the respective clocks. One way to synchronise the units is for them both to communicate with a separate reference time source. Another approach is to use the communication link 5 to help establish a common timebase between the units.

Some communication devices can provide a dedicated timing output. This timing output may be provided on a dedicated physical interface, or it may be implemented using a message sent over a multipurpose data interface. For example, a cellular modem circuit may be able to provide an output indicating the time as provided to it by a network in which it is communicating. Other communication devices may provide outputs indicating time with reference to some other clock. For example, a Bluetooth communication device may provide an output which reports time with respect to the Bluetooth master clock for a piconet in which it is participating.

Some communication devices do not provide a dedicated clock output mechanism. This may be because they do not maintain a reference clock, or it may be because their hardware is designed in such a way that it does not allow the state of their reference clock to be exposed externally.

There is a need for an improved way to derive a timing reference from a communication device.

According to one aspect there is provided a device comprising: a wireless communication interface, the communication interface being capable of using an external signal processing device to support a transmission or reception communication event and being configured to provide a first output signal from the communication interface for disabling such a signal processing device after the communication event; a clock external to the communication interface; and a synchronisation circuit configured to receive the first output signal and to synchronise the clock in dependence on the timing of the first output signal.

The wireless communication interface may be configured to use an external amplifier for amplifying signals to be transmitted by the interface. The wireless communication interface may be configured to provide the first output signal when transmission of a signal is complete.

The wireless communication interface may be configured to use an external amplifier for amplifying signals received by the interface. The wireless communication interface may be configured to provide the first output signal when reception of a signal is complete.

The wireless communication interface may be configured to provide a second output signal for indicating that the communication event is logically complete.

The second output signal may be provided as an interrupt.

The synchronisation circuit may be configured to synchronise the clock in dependence on the timing of the first output signal only if it detects the second output signal within a predetermined time after the first output signal.

The wireless communication interface may operate according to a protocol that provides for a synchronisation signal to be transmitted at a predetermined time by one participant in a network and received by all other participants in the network, and wherein the communication event is the transmission or reception of such a signal.

The synchronisation circuit may be configured to determine whether the first output signal relates to an event that is the transmission or reception of a synchronisation signal and to synchronise the clock in dependence on the timing of the first output signal only if that determination is positive in respect of the first output signal.

The synchronisation circuit may be configured to synchronise the clock by adjusting the phase of the clock in dependence on the timing of the first output signal.

The device may comprise a counter configured to count at a frequency dependent on the output of the clock and the synchronisation circuit is configured to synchronise the clock by adjusting the counter in dependence on the timing of the first output signal.

The device may comprise a counter configured to count at a frequency dependent on the output of the clock and the synchronisation circuit is configured synchronise the clock by storing the value of counter at the time of the first output signal.

The device may comprise a sensor for sensing an environmental characteristic and generating sensed data indicative of the sensed characteristic, and the device being configured to represent the time of the sensed data with reference to the synchronised clock.

According to another aspect there is provided a method for synchronising two devices, each device having a communication circuit implemented as an integrated circuit, a first one of the communication circuits having (i) a first signal output for presenting a signal for transmission to an external amplifier, (ii) a first signal input for receiving a signal for transmission from an external amplifier, that one of the communication circuits being configured to cause a signal received at the signal input to be transmitted, and (iii) a first control output for signalling when an external amplifier coupled between the first signal output and the first signal input is to be active, and a second one of the communication circuits having (i) a second signal output for presenting a received signal to an external amplifier, (ii) a second signal input for receiving an amplified signal from an external amplifier, that one of the communication circuits being configured to perform signal decoding on a signal received at the signal input, and (iii) a second control output for signalling when an external amplifier coupled between the signal output and the signal input is to be active; the method comprising determining the relative timings of events sensed by the devices in dependence on the timings of signals at the first and second control outputs. The first and second control outputs may be outputs from the respective integrated circuits.

Each device may comprise a clock external to the communication circuit. The method may comprise synchronising the clocks in dependence on the timings of signals at the first and second control outputs.

The method may comprise timing a first event at a first one of the devices with reference to its clock and timing a second event at a second one of the devices by reference to its clock.

The present invention will now be described by way of example with reference to the accompanying drawings.

In the drawings:

FIG. 1 is a schematic diagram of a generalised system comprising two units.

FIG. 2 shows the architecture of a sensor system.

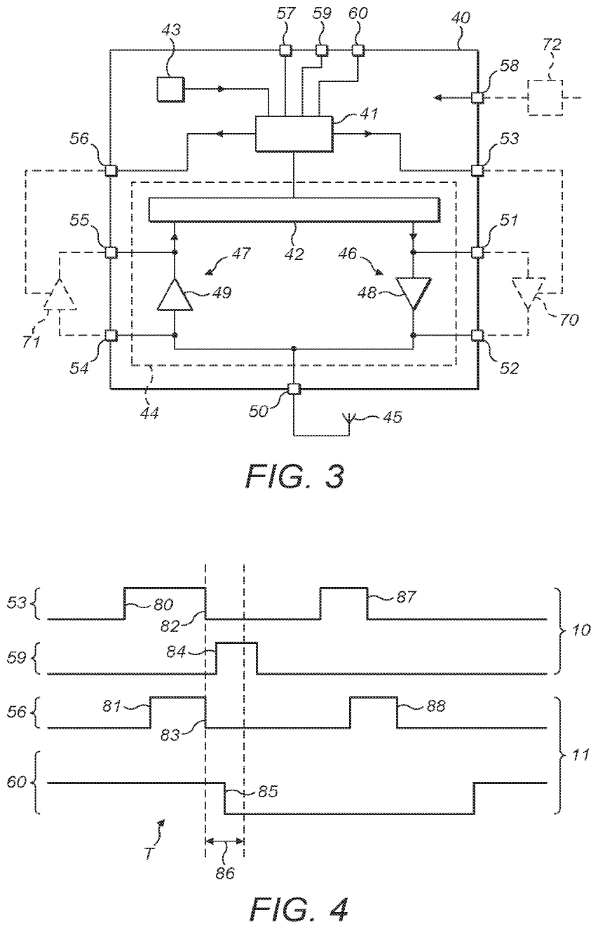

FIG. 3 shows a wireless communication interface.

FIG. 4 shows signal timings.

FIG. 2 shows a system having multiple intercommunicating sensing units. The units are designated 10, 11, 12. Each unit may be a discrete element having its own outer housing. Each unit may be separate from and moveable independently with respect to the other units. For example, each unit may be an individual portable sensing unit.

Analogous components of each sensing unit are designated with the same reference numbers. Each unit has a wireless communication interface 13 coupled to an antenna 14, a processor 15, a memory 16, sensors 17 and a battery 18. In each unit, the communication interface 13 implements a wireless communication protocol for transmitting and receiving data via the antenna 14. The communication interface includes a radio frequency (RF) front-end 19, a digital signal processor (DSP) 20 and a clock 21. The memory 16 stores in a non-transient way program code executable by the processor 15 to cause it to perform its functions. The sensors 17 are configured to sense environmental data and pass the results of such sensing to the processor. The battery powers 18 the operations of the unit.

The communication interfaces 13 of the units are capable of communicating wirelessly with each other as indicated at 22. The topology of the network formed by the communication interfaces can take any suitable form. For example, each communication interface may communicate with all the others, e.g. in a mesh; or each communication interface may communicate with only a single one of the others, that single unit acting as a master for controlling aspects of the operation of the network; or a device may act as a master and a slave simultaneously, e.g. in different networks or sub-parts of a network. The communication interfaces may use any suitable protocol. Examples include IEEE 802.11 and Bluetooth. The communication interfaces may communicate in the ISM band or in any other suitable frequency band.

The clock may comprise an oscillator which provides a regular stream of pulses to the DSP 20. The DSP may count those pulses to provide a measure of time for use by the respective communication interface.

When the units are operating, their sensors 17 sense environmental data. Examples of what this environmental data may represent will be given below. The results of the sensing can be passed to the respective unit's processor 15. The processor may store the data in memory 16. The processor may signal the unit's communication interface 13 over a data link 23 between the processor and the communication interface to cause the communication interface to transmit the sensed data. That data can then be uploaded to another unit for further analysis or for display to a user. The sensed data may be extracted from the units by other interfaces, for example via a wired link.

When an event is sensed by one of the sensors it may be desirable to relate the time of that event to the times of other events sensed by others of the units. Ways in which that may be done will now be described.

FIG. 3 shows an example architecture for a communication interface 40, which may serve as an interface 13 in the architecture of FIG. 2. The interface 40 may conveniently be implemented on a single integrated circuit, but it may alternatively be implemented using multiple integrated circuits and/or discrete components. The interface includes a DSP 41, an RF front-end 44 and a clock 43. For clarity, the majority of the RF front-end is not shown in detail and is represented by block 42. Input and/or output nodes to and/or from the interface are shown at 50-60. When the communication interface 40 is implemented as a single integrated circuit, these may each be constituted by one or more connection pads. Connection pad 50 is provided for coupling the communication interface 40 to an external antenna 45. The communication interface may alternatively have an internal antenna. The communication interface 40 has a transmit path shown generally at 46 for carrying signals that are to be transmitted to the antenna port 50, and a receive path shown generally at 47 for carrying signals received at the antenna to the block 42 for processing.

In the transmit path 46, signals generated by the processing block 42 of the RF front-end are amplified by a power amplifier (PA) 48 for transmission. The architecture shown in FIG. 3 provides for two amplification mechanisms. First, the communication interface includes the power amplifier 48 arranged in the transmit path 46. Second, the communication interface includes connectors 51,52 arranged in the transmit path. An external amplifier shown at 70 can be connected across these connectors and used to amplify the signals for transmission. To avoid the need for that external amplifier to be powered for longer than necessary, a power amplifier control output 53 is provided. This is controlled by the DSP 41. The power amplifier control output signals when transmission is to take place. For example, it may be high when the external amplifier is to be powered, and low otherwise. In implementations that use an external amplifier, the signal at the power amplifier control output can be used to control a switch which turns power to the external power amplifier on or off. Put another way, external amplifier 70 can be activated in response to the power amplifier control signal.

In the receive path, signals received at the antenna 45 are amplified by a low noise amplifier (LNA) 49 for subsequent processing. The architecture shown in FIG. 3 provides for two amplification mechanisms. First, the communication interface includes the low noise amplifier 49 arranged in the transmit path 47. Second, the communication interface includes connectors 54, 55 arranged in the transmit path. An external amplifier shown at 71 can be connected across these connectors and used to amplify the received signals. To avoid the need for that external amplifier to be powered for longer than necessary, an LNA control output 56 is provided. This is controlled by the DSP 41. The LNA control output signals when transmission is to take place. External amplifier 71 can be activated in response to that signal.

The communication interface has a data connector 57. This allows data to be passed to the interface for transmission, and allows received data to be passed out of the interface, e.g. to processor 15 of FIG. 2. Connector 57 may comprise multiple physical pads which operate in parallel to transmit or receive data. Connector 57 may couple to data line 23 of FIG. 2.

The clock 43 is an oscillator. The clock generates a regular stream of output pulses. These are received by the DSP 41. The DSP 41 counts the pulses to form an indication of the current time from the perspective of the DSP. Some communication protocols may provide for time to be synchronised between participants in a communication network operating according to such a protocol. This may involve one or more devices transmitting their current time to one or more other devices in the network. An offset between the clocks may then be determined, and may be stored by one or both devices. Synchronisation may involve one or more devices adjusting their clocks to bring its clock transitions into closer alignment with the clock transitions of the clocks of one or more other devices in the network.

For example, a device A may have a current clock value of 2384 and a device B may have a current clock value of 2484. In one form of synchronisation each device may transmit its current clock value to the other. Each device may then store the offset from its own clock of the other device's clock. Device A may store +100 and device B may store −100. Then the devices can interrelate times in the clocks of either device. Alternatively, given the clock values stated above, device A may reset its clock to 2484, the value of B's clock. Then the offset is zero. Other forms of synchronisation are possible. For example the offset could be reset to a value other than zero, or both clocks could be reset simultaneously to a predetermined value, or an offset between the clocks could be stored at a third device. In each case, the outcome is that data is available whereby a time as indicated by one clock can be temporally related to a time as indicated by the other clock.

The communication interface 40 has a power input 58 for receiving electrical power to operate the interface. A power sensing circuit 72 may be located in the power supply to the power input for measuring power supplied to the interface.

The connections 51, 53, 54, 56 may be coupled to the processor 15 of the respective sensing unit by way of a probe connection 24. The probe connection may also carry a signal indicating the state of the power sensing circuit 72. The probe connection may have a dedicated line for each of the connections 51, 53, 54, 56 so that it the processor can sense in real time the state of each of those outputs from the communication interface.

The communication interface supports a protocol according to which signals are transmitted in packets. The packets are transmitted according to a transmission schedule. The schedule is defined at least in part by the protocol, and may additionally be dependent on parameters defined by one or more of the participants and transmitted to one or more other participants. For example, the protocol may define a schedule according to which one of the participants may transmit to one of the other participants at a predefined time. This allows the participant that is intended to act as receiver to operate in a relatively low power state until the time when a communication might be directed to it, and then to enter a higher power state with its reception capabilities enabled for the period when a transmission is expected. One illustrative example of a protocol that works in this way is Bluetooth.

When the communication interface 40 is to make a transmission, the DSP 41 forms the digital data to be transmitted. If that is data purely for supporting the protocol then the data may be generated by the DSP. If the data is traffic data, for example an indication of a condition sensed by a sensor 17 then it may be received from the processor over link 23 and connector 57. The DSP then passes the data for transmission to the RF front-end 42. It also signals at port 53 that any external amplifier 70 can be turned on. A first state (e.g. low) of port 53 may indicate that the external amplifier is not to be enabled, and a second state (e.g. high) of port 53 may indicate that the external amplifier is to be enabled. Then analogue signals for transmission are formed by the block 42 and passed to amplifier 48. Those signals are also passed to port 51 so that they can be input to any external amplifier. The amplified signals then pass to the antenna 45 for transmission. When the amplifier 48 is operating, the power drawn by the communication interface 40 may increase. That may be sensed by power sensing circuit 72. When the communication interface has successfully made a data transmission, it may signal that externally, e.g. over connector 57 or using a dedicated “TX successful” line terminating at a connector pad 59. A data transmission may be deemed successful if the act of transmitting the signal is completed without error, or if an acknowledgement of the transmission is received. Pad 59 may be connected to the probe connection 24.

When the communication interface 40 is to make a reception, RF signals impinging on the antenna 45 pass to the LNA, which amplifies them and passes them to the RF front-end for processing. The output of the RF front-end passes to the DSP, which decides what data (if any) is contained in the signals. If the data relates purely to supporting the protocol then it may be used internally by the DSP. If the data is intended for another consumer, e.g. at user level, then the DSP transmits the data via connector 57. When the DSP is expecting to receive data it signals at port 56 that any external amplifier 71 can be turned on. A first state (e.g. low) of port 56 may indicate that the external amplifier is not to be enabled, and a second state (e.g. high) of port 56 may indicate that the external amplifier is to be enabled. When the amplifier 49 is operating, the power drawn by the communication interface 40 may increase. That may be sensed by power sensing circuit 72. When the communication interface has successfully made a data reception, it may signal that externally, e.g. over connector 57 or using a dedicated “RX ready” line terminating at a connector pad 60. A data reception may be deemed successful if the received data, taking a predetermined format, has reached an end; or if a predetermined period has elapsed since the last data was received. Pad 60 may be connected to the probe connection 24. The signals representing the logical results of transmission and/or reception operations, e.g. as provided to pins 59, 60, may be provided as interrupts.

FIG. 4 shows the state of the outputs 53, 59, 56 and 60 for two separate communication interfaces when a scheduled transmission is taking place. In this example, a transmission takes place from unit 10 to unit 11. The plots in FIG. 4 show, in order starting from the top of the figure, the states of:
pad 53 of the communication interface of unit 10;
pad 59 of the communication interface of unit 10;
pad 56 of the communication interface of unit 11;
pad 60 of the communication interface of unit 11.

A packet is expected to be transmitted at the time indicated in FIG. 4 as T. This time is known to the communication interfaces of units 10 and 11 because the clocks of their communication interfaces are synchronised and the time T is defined by the protocol they are using. In advance of time T, the communication interface of unit 10 prepares for transmission by enabling its external transmit amplifier (if any) as indicated by a change of state (80) of pad 53. In advance of time T, the communication interface of unit 11 prepares for reception by enabling its external receive amplifier (if any) as indicated by a change of state (81) of pad 56. Then the communication interface of unit 10 transmits a packet to the communication interface of unit 11. Once the packet has been transmitted the transmitting interface disables its external transmit amplifier (transition 82) and the receiving interface disables its external receive amplifier (transition 83). It is logical for these transitions to take place promptly after the end of transmission and reception since that minimises potential power draw from an external amplifier. When transmission has taken place, the transmitting interface signals that by means of a “TX successful” event. That may be a transition (84) on pad 59 or it may be provided as a message over line 24. When reception has taken place, the receiving interface signals that by means of an “RX ready” event. That may be a transition (85) on pad 60 or it may be provided as a message over line 24. The significance of these signals may vary. For example, the transmitting interface could generate a “transmit ready” signal or the receiving interface could generate an “RX complete” signal.

At the processors 15 of the respective sensing units, the pins 53, 59, 56 and 60 are monitored. If the signals indicated in FIG. 4 as being carried by pins 59 and 60 are passed over link 23 then they could be monitored in that way. It should be noted that it does not matter whether either unit has an external amplifier 71, 72: the signals to control such an amplifier can be monitored irrespective of whether such an amplifier is present.

At unit 10, when transition 82 (a transition indicating the end of a transmission) occurs the processor records the time of that with reference to its local clock 25. For example, it may store the state of the clock counter, or reset it to a predetermined value such as zero, at that point. It may adjust the phase of the local clock 25 so that a predetermined point in the clock's phase matches the timing of the relevant transition. That point may serve as a reference time for subsequent events. When events are subsequently sensed by the sensors 17, they may be timestamped by the processor 15 with the time of its clock. That is, each event may have a time associated with it, which is the time of the clock 25 when the event was sensed. That time may be stored by the processor together with data defining the event (e.g. the actual sensed data) in memory 16. The processor may cause the time and the data defining the event to be transmitted over an external interface from the unit 10. At unit 11, when transition 83 (a transition indicating the end of a reception) occurs the processor records the time of that with reference to its local clock 25. For example, it may store the state of the clock counter, or reset it to a predetermined value such as zero, at that point. It may adjust the phase of the local clock 25 so that a predetermined point in the clock's phase matches the timing of the relevant transition. That point may serve as a reference time for subsequent events. When events are subsequently sensed by the sensors 17, they may be timestamped by the processor 15 with the time of its clock. That is, each event may have a time associated with it, which is the time of the clock 25 when the event was sensed. That time may be stored by the processor together with data defining the event (e.g. the actual sensed data) in memory 16. The processor may cause the time and the data defining the event to be transmitted over an external interface from the unit 11. Because the transitions 82 and 83 are close together in time, the clocks 25 of the processors 15 of units 10 and 11 can be closely synchronised by this mechanism. This allows events timestamped with the clocks to be accurately interrelated in time, even though the clocks 43 of the communication interfaces of units 10 and 11 are not explicitly exposed externally. It has been found that using this mechanism events can in some circumstances be interrelated to less than 2 μs.

It is possible that the pins 53, 56 may transition as if to indicate the end of transmission or reception at times when transmission or reception has not occurred. Examples are shown in FIG. 4 at 87 and 88. To avoid these events upsetting the synchronisation of units 10 and 11, each processor 15 applies a time window 86 of a predefined duration after each transition indicating the end of transmission or reception. A transition is ignored for synchronisation purposes if the respective signal indicating successful transmission or reception (e.g. 84, 85) does not occur within that window. This method can reduce the chance that the synchronisation between units is mistakenly adjusted.

A further mechanism is to synchronise the devices based on the timing of the informational signals 84, 85 indicating that transmission and reception have ended. A disadvantage of this is that those signals can be offset in tie by a greater amount than the amplifier control signals indicating an end of amplifier demand as at 82 and 83.

Different mechanisms to trigger synchronisation may be employed at the transmitter and the receiver. For example, one may rely on one of the transitions 82, 83 and another may rely on one of the transitions 84, 85.

The processor 15 may use additional information to help decide when to synchronise its clock. In one example, the communication interface may indicate (e.g. over link 23) when a packet is being sent that is scheduled to be received by all participants in a network. That may be a synchronisation packet in a Bluetooth network. The system can usefully use such a packet for synchronisation because it can be expected that all participants in the network will either transmit or receive that packet. The processor may ignore signals indicating the end of transmission or reception, or successful transmission or reception, except those that relate to such packets. The communication interface may also signal whether it is to transmit or receive such a packet. This may enable the processor to selectively observe events relating to transmission or reception in response to such a signal.

The processor may detect that a received or transmitted signal is to be used or not used for synchronisation in dependence on the length of time for which an external amplifier is enabled during transmission or reception. That may indicate the type of signal being transmitted or received.

The processor may employ data relating to the power consumption of the communication interface to assist synchronisation. When one of the amplifiers 48, 49 is active the power consumption of the communication interface can be expected to be relatively high. When transmission or reception is complete the communication interface may deactivate that amplifier and power consumption may reduce. This may provide a signal from sensor 72 of similar shape to the first and third plots in FIG. 4, from which the processor can infer synchronisation in an analogous way to that described above.

Thus, in preferred aspects of the method described above, the processor of a unit comprising a wireless communication interface identifies a transition in an electrical signal external to the communication interface. That may, for example be a signal representing a demand for an external component to support the interface in transmission or reception, or a transition in power consumption by the interface. When the signal being sensed is binary, the transition may be recognised by virtue of it having a predetermined direction (e.g. low to high). When the signal being sensed is analogue, the transition may be recognised by virtue of it transitioning between two predetermined values. The transition may indicate the end of a transmission or reception event. The processor may be configured to synchronise the clock to such a signal only when the circumstances surrounding the signal meet other criteria, for example that one or more transitions of the same or other signals occur in a predetermined order and within a predetermined time of the primary signal. The processor may be configured so that it only resets the clock if those criteria are met.

It is convenient for the communication interfaces to operate according to a protocol in which communications are scheduled, but that is not essential. External amplifiers may be disabled after transmission for other reasons, and the end of transmission or reception may be signalled by informational signals in protocols of other types.

In the examples given above, the signals at pins 53, 56 are for enabling external amplifiers. They could each be for enabling any other external components that are for use during transmission or reception, for example a filter, a mixer or an oscillator. When such an external component is capable of being used for transmission, the communication interface may include a first output (51) for providing a radio frequency signal representing a signal to be transmitted and an second input (52) coupled to the antenna for receiving a signal formed by such an external device in dependence on the signal provided at the first output. When such an external component is capable of being used for reception, the communication interface may include a second output (54) coupled to the antenna for providing a radio frequency signal representing a received signal and a second input (55) coupled to processing circuitry of the communication interface (e.g. 42, 41) for receiving a signal formed by such an external device in dependence on the signal provided at the first output.

In the example given above, the operation of synchronising the local clock to the relevant timing signal is performed by a processor circuit executing software. The operation could alternatively be performed by dedicated hardware circuitry.

The units 10, 11, 12 may be configured for any suitable sensing activity. In one example, they may be capable of sensing the same characteristics at their respective locations. Examples of parameters that may be sensed by the sensors 17 include acceleration, orientation, temperature, pressure, light, sound, fluid flow, blood pressure and pulse rate. In one convenient example the units 10, 11, 12 are configured to be worn by a human or animal subject. They may be worn at different locations on the body to sense motion of the respective body part. By correlating the times of motion events by the mechanism described above, the motion of the subject's body parts can be inter-related.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

What is claimed is:

1. A system for synchronising two devices, the system comprising:
a first device comprising:
a first communication circuit implemented as an integrated circuit, having (i) a first signal output configured for presenting a signal for transmission to an amplifier, (ii) a first signal input configured for receiving a signal for transmission from the amplifier, with the first communication circuit configured to cause a signal received at the signal input to be transmitted, and (iii) a first control output configured for signaling when the amplifier coupled between the first signal output and the first signal input is to be active; and
a second device comprising:
a second communication circuits having (i) a second signal output configured for presenting a received signal to an amplifier, (ii) a second signal input configured for receiving an amplified signal from the amplifier, with the second communication circuit being configured to perform signal decoding on a signal received at the signal input, and (iii) a second control output configured for signaling when the amplifier coupled between the signal output and the signal input is to be active;
wherein the system is configured to determine a relative timings of events sensed by the first and second devices in dependence on the timings of signals at the first and second control outputs.

2. The system of claim 1, wherein the first and second devices comprise a clock external to the first and second communication circuits, and the system is configured to synchronize the clocks in dependence on the timings of signals at the first and second control outputs.

3. The system of claim 2, wherein the system is configured to time a first event at the first device with reference to its clock and time a second event at the second device by reference to its clock.

4. The system of claim 3, wherein the system is configured to provide the second signal output for indicating that the events are logically complete.

5. The system of claim 4, wherein the second signal output is provided as an interrupt.

6. The system of claim 5, wherein the system is configured to synchronise the clock in dependence on the timing of the first signal output only if it detects the second signal output within a predetermined time after the first output signal.

7. The system of claim 1, wherein the system operates according to a protocol that provides for a synchronisation signal to be transmitted at a predetermined time by one participant in a network and received by all other participants in the network, and wherein the event is the transmission or reception of such a signal.

8. A method for synchronising two devices, each device having a communication circuit implemented as an integrated circuit, a first one of the communication circuits having (i) a first signal output for presenting a signal for transmission to an amplifier, (ii) a first signal input for receiving a signal for transmission from the amplifier, that one of the communication circuits being configured to cause a signal received at the signal input to be transmitted, and (iii) a first control output for signaling when the amplifier coupled between the first signal output and the first signal input is to be active, and a second one of the communication circuits having (i) a second signal output for presenting a received signal to an amplifier, (ii) a second signal input for receiving an amplified signal from the amplifier, that one of the communication circuits being configured to perform signal decoding on a signal received at the signal input, and (iii) a second control output for signaling when the amplifier coupled between the signal output and the signal input is to be active; the method comprising determining the relative timings of events sensed by the devices in dependence on the timings of signals at the first and second control outputs.

9. The method as claimed in claim 8, wherein each device comprises a clock external to the communication circuit, and the method comprises synchronising the clocks in dependence on the timings of signals at the first and second control outputs.

10. A method as claimed in claim 9, further comprising timing a first event at a first one of the devices with reference to its clock and timing a second event at a second one of the devices by reference to its clock.

11. The method of claim 10, wherein the integrated circuit is configured to provide the second signal output for indicating that the events are logically complete.

12. The method of claim 11, wherein the second signal output is provided as an interrupt.

13. The method of claim 12, wherein the integrated circuit is configured to synchronise the clocks in dependence on the timing of the first signal output only if it detects the second signal output within a predetermined time after the first output signal.

14. The method of claim 8, wherein the integrated circuit operates according to a protocol that provides for a synchronisation signal to be transmitted at a predetermined time by one participant in a network and received by all other participants in the network, and wherein the event is the transmission or reception of such a signal.
